(19) United States
(12) Patent Application Publication
(10) Pub. No.: US 2022/0399764 A1
(43) Pub. Date: Dec. 15, 2022

(54) SYNCHRONOUS ELECTRIC MACHINE WITH RELUCTANCE ASSISTED BY PERMANENT MAGNETS AND PROCESS FOR MAKING SUCH ELECTRIC MACHINE

(71) Applicant: MAVEL EDT S.P.A., Pont Saint Martin (AO) (IT)

(72) Inventors: Luca FAVRE, Valpelline (AO) (IT); Davide BETTONI, Settimo Vittone (TO) (IT)

(21) Appl. No.: 17/776,296

(22) PCT Filed: Nov. 12, 2019
(86) PCT No.: PCT/IT2019/000098

§ 371 Date: May 12, 2022

(51) Int. Cl. H02K 1/16; H02K 1/276; H02K 3/12; H02K 15/03; H02K 15/085

(52) U.S. Cl. CPC H02K 1/165; H02K 1/276; H02K 3/12; H02K 15/03; H02K 15/085

(57) ABSTRACT

A synchronous electric machine with reluctance assisted by permanent magnets is described, comprising a rotor comprising: a lamellar pack fastened on a rotation shaft and comprising identical sheets, each comprising first axial recesses and permanent magnets, and second axial recesses to form flow barriers; a stator with a first, internal stator part comprising longitudinal teeth; a second, external annular stator part, with seats complementary with the teeth in order to form the closed slots and the stator; a continuous winding with a strap, configured to be wound on the first, internal stator part; a process for making such synchronous electric machine is further described.

The present invention refers to a synchronous electric machine with reluctance assisted by permanent magnets and to a process for making such electric machine.

In particular, the invention refers to a synchronous electric machine with reluctance assisted by permanent magnets free from rare earths, with a stator with closed slots comprising a continuous winding made by using a metallic slat.

Known electric machines comprise a fixed part, the stator, and a moving part, the rotor, arranged coaxially one inside the other. Typically, the rotor comprises a pack of sheets fastened onto a rotation shaft, and is inserted inside the stator, which comprises an electric winding adapted to generate a magnetic field which rotates the rotor.

The stator generally is of an annular shape and comprises a plurality of radial slots, inside which the electric winding is made.

Rotor sheets comprise housings for permanent magnets and recesses configured to create flow barriers which direct the magnetic flow of the magnet towards the stator.

In synchronous electric machines with reluctance assisted by permanent magnets, in particular in reluctance motors, for example for applications in the motor vehicle field, rotors are used with permanent magnets made by using rare earths, which allow making high-performance motors with limited encumbrance, but have various problems such as high extraction cost, also in terms of process pollution, and availability, also due to the greater and greater use in electronic devices and in the motor vehicle sector, with the increase of the diffusion of hybrid and electric cars.

Another aspect of electric machines, relevant as regards performances, is the electric windings of the stators.

In particular, for making the electric windings of the stator with closed slots, it is known to use copper bands, which are bent in their central part to form straps shaped as a hairpin, called “hairpins”, to be inserted in the slots of the stator.

Shape and bending angle of the bands change when the geometry of the stator and of the slots changes, and when the winding scheme changes.

These straps are inserted into the slots of the stator from the same side, with the two terminals of every strap inserted in different slots, according to a certain scheme, to obtain the exact number of coils necessary to compose the desired winding; the ends of the straps which project from the slots are bent with a twisting process, to prevent them from going out, and are then mutually welded, after having removed the insulating material from the welding area, in order to create a correct connection between the different copper straps to form the stator winding.

This known process ends with insulating the welding areas through resins; finally, the stator and the straps are made integral by immersing their ends into a resin.

The stators made with such known process of making the windings through the use of hairpins have a series of problems, caused by the several welding spots being present in the winding, which cause an increase of the resistance to the passage of current and which require the presence of several quality controls for the welding, by the process complexity, with problems linked for example to the need of insulating the winding with resins, to the process complexity and the limits to the length which can be used for bands, due to the difficulty of inserting it into the stator slots, in particular in the closed slots.

Object of the present invention is solving these problems through a synchronous electric machine with reluctance assisted by permanent magnets and a process for making such electric machine, which allow making a rotor which allows using permanent magnets free from rare earths, a better efficiency of the electric machine due to a drastic reduction of the number of welding spots being present in the stator winding, a lower insulation through resins, a reduction of the resistance to the passage of current in the winding, the removal of the twisting process, a reduction of quality controls within the process, making it possible to obtain windings on stators with a greater active lengths, with lower costs, better filling of the slots by the winding and in general a better efficiency of the electric machine being made.

The above and other objects and advantages of the invention, as will result from the following description, are obtained with a synchronous electric machine with reluctance assisted by permanent magnets and with a process for making such electric machine as claimed in the independent claims.

Preferred embodiments and non-trivial variations of the present invention are the subject matter of the dependent claims.

It is intended that all enclosed claims are an integral part of the present description.

It will be immediately obvious that numerous variations and modifications (for example related to shape, sizes, arrangements and parts with equivalent functionality) can be made to what is described, without departing from the scope of the invention, as appears from the enclosed claims.

The present invention will be better described by some preferred embodiments thereof, provided as a non-limiting example, with reference to the enclosed drawings, in which:

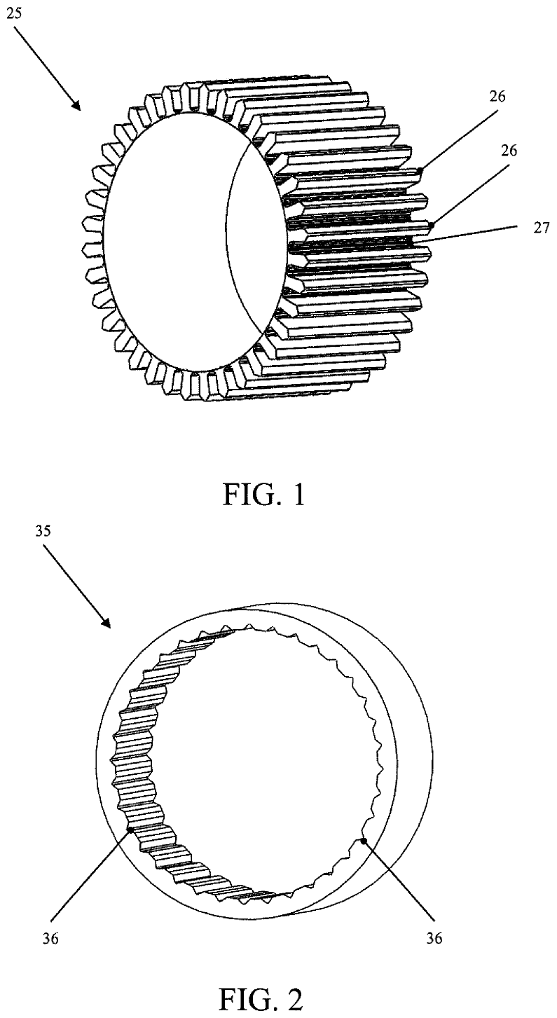

FIG. 1 shows a perspective view of an internal part of a stator of an electric machine of the invention;

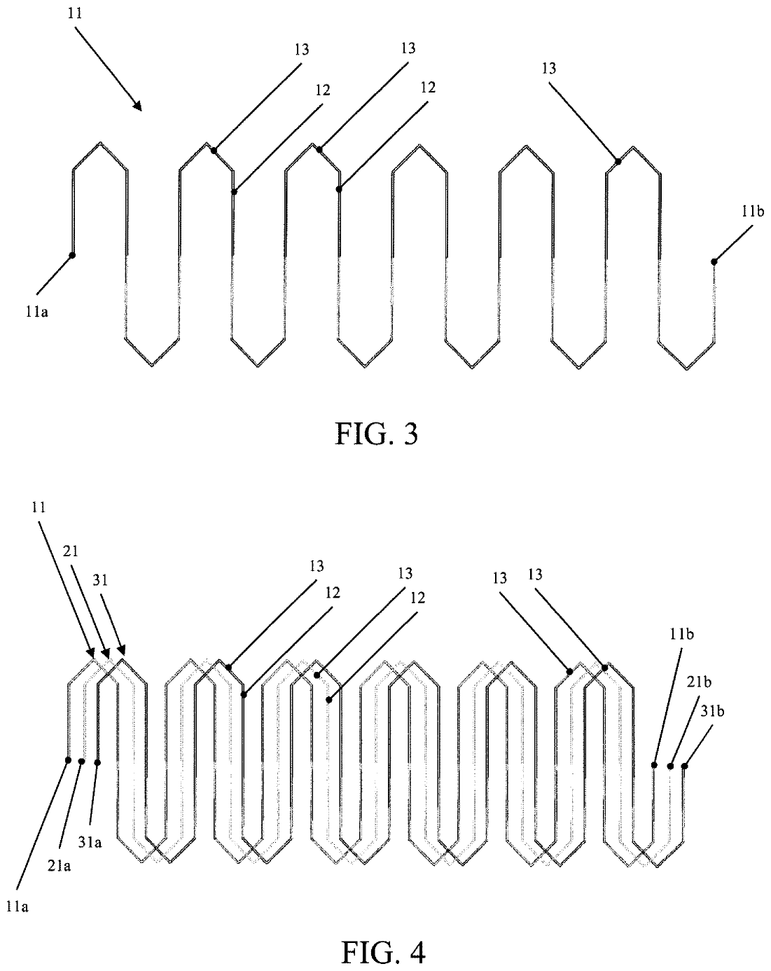

FIG. 2 shows a perspective view of an external part of a stator of an electric machine of the invention;

FIG. 3 shows a view of a continuous winding for a stator of an electric machine of the invention;

FIG. 4 shows a view of a plurality of continuous windings for a stator of an electric machine of the invention;

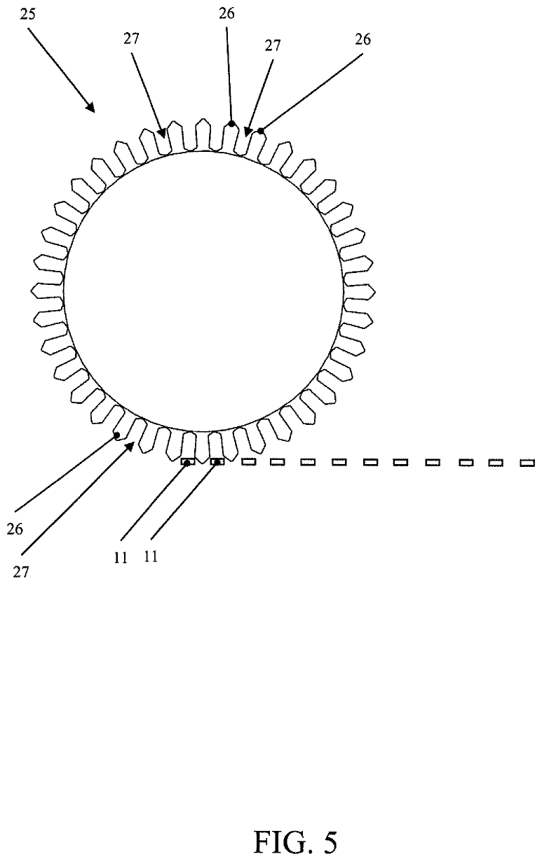

FIG. 5 shows a schematic view of an internal part of a stator of the invention;

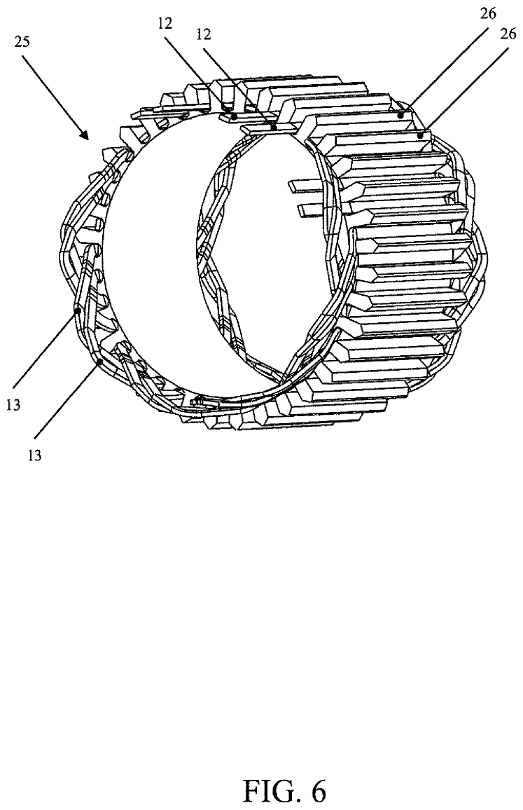

FIG. 6 shows a perspective view of an internal part of a stator of the invention;

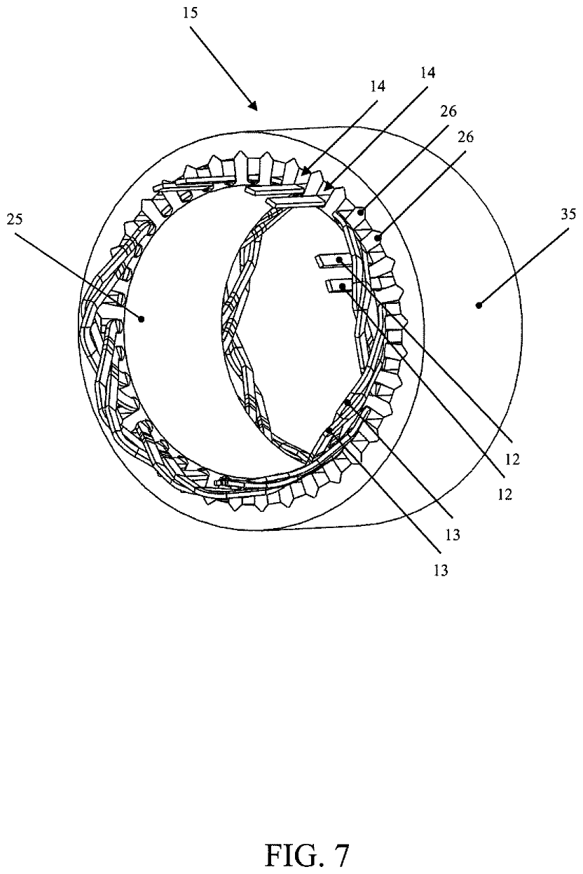

FIG. 7 shows a perspective view of a stator of an electric machine with a continuous winding of the invention; and

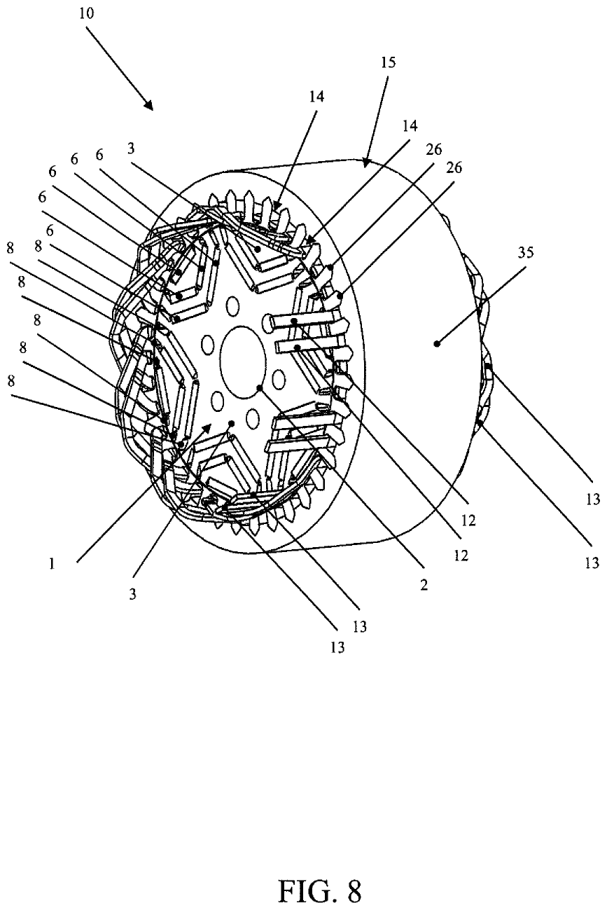

FIG. 8 shows a perspective view of a synchronous electric machine with reluctance assisted by permanent magnets of the invention.

With reference to the Figures, the synchronous electric machine 10 with reluctance assisted by permanent magnets of the invention, for example a synchronous motor, will be described below, comprising a rotor 1 comprising: a lamellar pack fastened on a rotation shaft and comprising a plurality of identical sheets 3, comprising a central hole 2 crossed by the rotation shaft and a plurality of axial recesses 6, 8 which cross the sheets 3 from side to side. In particular, each sheet 3 comprises: a plurality of first axial recesses 6, for example having a trapezoidal, rectangular or square shape, arranged substantially along a radial direction and/or a slanted radial direction, one below the other and mutually spaced, and permanent magnets, preferably permanent magnets free from rare earths, shaped as bars inserted in the first axial recesses 6; a plurality of second axial recesses 8 having a substantially radial and/or slanted radial direction which start from the first axial recesses 6 and arrive next to the edge of a sheet 3, to form the flow barriers.

The synchronous electric machine 10 with reluctance assisted by permanent magnets of the invention further comprises a stator 15 with closed slots with continuous winding, which comprises a first, internal stator part 25 comprising a plurality of longitudinal teeth 26, spaced by a space 27 configured to make the lower part of the closed slots 14 of the stator, and a second, external annular stator part 35, comprising a plurality of seats 36 complementary with the teeth 26 in the first stator part 25 and configured to be meshed with the first stator part 25 in order to form the closed slots 14 and the stator 15; in particular, said seats 36 obtained in the second stator part 35 are configured to mesh with the W teeth 26 of the first stator part 25 in order to form the closed stator slots 14, through a mutual sliding movement of the first, internal stator part 25 and of the second external part 35, for example along the direction of the axis of the stator 15, making a coupling, for example of the dovetail type or other known coupling type.

The stator 15 with closed slots of the invention comprises a continuous winding comprising at least one strap 11, 21, 31, which in turn comprises a plurality of first sectors 12 mutually connected by a plurality of second sectors 13 alternate thereto, said at least one strap 11, 21, being configured to be wound on the first, internal stator part 25, by placing the first sectors 12 of the straps 11, 21, 31 into the spaces 27 included between the teeth 26. In a preferred way, the first sectors 12 are mutually parallel, being every first sector 12 connected with at least one end thereof to a second sector 13, and the winding comprises three, mutually alternated straps 11, 21, 31.

The process for making a synchronous electric machine 10 with reluctance assisted by permanent magnets of the invention comprises the following steps:
a step of making, in a known way, a rotor 1 by making a lamellar pack fastened on a rotation shaft and comprising a plurality of identical sheets 3, comprising a central hole 2 crossed by the rotation shaft and a plurality of axial recesses 6, 8 which cross the sheets 3 from side to side, each sheet 3 comprising: a plurality of first axial recesses 6, radially arranged one below the other and mutually spaced, and permanent magnets, preferably permanent magnets free from rare earths, shaped as bars inserted in the first axial recesses 6; a plurality of second axial recesses 8 having a slanted radial direction which start from the first axial recesses 6 and arrive next to the edge of a sheet 3, to form the flow barriers;
a step of bending on a plane at least one strip, for example with section having side whose sizes are included between 1 mm and 7 mm, and strip length between 400 mm and 1000 mm, to make at least one strap 11, 21, 31 in a single piece, typically a strap 11, 21, 31 for every electric phase, for example three straps 11, 21, 31 in case of a three-phase current, each strap 11, 21, 31 comprising a plurality of first sectors 12, preferably equal in shape and sizes and mutually parallel, preferably substantially rectilinear, configured to be inserted inside closed slots 14 of a stator 15 and mutually connected by a plurality of second bending sectors 13, in a preferred way mutually equal regarding shape and sizes, and configured to remain outside the closed slots 14 of the stator 15; in particular, the first sectors 12 and the second sectors 13 are mutually alternate, every first sector 12 being connected with at least one end thereof to a second sector 13, preferably being the two ends of each first sector 12 connected to two different second sectors 13. In a preferred way, the section of each strap 11, 21, 31 has the shape of the section of the closed slots 14 of the stator 15 so that, once inserted into said closed slots 14, the strap 11, 21, 31 completely fills them;
a step of providing the stator 15, said stator comprising a first internal stator part 25 comprising a plurality of longitudinal teeth 26, spaced by a space 27 configured to make the lower part of the closed slots 14 of the stator, and a second external annular part 35 of the stator, comprising a plurality of seats 36 complementary to the teeth 26 of the first stator part 25 and configured to be meshed with the first stator part in order to form the closed slots 14 and the stator 15; in particular, said seats 36 obtained in the second stator part 35 are configured to mesh with the teeth 26 of the first stator part 25 in order to form the closed stator slots 14, through a mutual sliding movement of the first, internal stator part 25 and of the second external part 35, for example along the direction of the axis of the stator 15, making a coupling, for example of the dovetail type or other known coupling type;
a step of making the winding on the first, internal stator part 25 of said at least one strap 11, 21, 31, in a preferred way of said three mutually alternated straps 11, 21, 31, by placing the first sectors 12 of strap 11, 21, 31 in the spaces 27 included between the teeth 26; in particular, the strap 11, 21, 31 is wound on the first stator part 25 in order to mesh it between the teeth 26 of the first, internal stator part 25, similarly to how a chain is meshed onto the teeth of a gear, through a relative rotation of the first, internal stator part 25 with respect to the strap 11, 21, 31, as shown in FIG. 5; in particular, the number of rotations is equal to the number of slot coils;
a step of connecting, preferably through welding, the two free ends 11a and 11b, 21a and 21b, 31a and 31b of every strap 11, 21, 31;
a step of insulating the welding spots in a known way, for example through epoxy deposited through dripping;
a step of positioning the second, external stator part 35 on the first, internal stator part so that the seats 36 obtained in the second, external stator part 35, by being meshed with the teeth 26 of the first, external stator part 25, form the closed slots 14 of the stator 15;
a step of checking the absence of connection errors, welding problems or of short-circuit problems among the different electric phases;
a step of resin coating, through immersion of the ends of the straps 11, 21, 31 projecting from the closed slots 14 and of the heads of the stator 15 into a resin configured to make the stator 15 and the straps 11, 21, 31 mutually integral, avoiding future damages due to vibrations;
a step of placing the rotor 1 inside the stator 15.

Advantageously, the synchronous electric machine 10 with reluctance assisted by permanent magnets and the process for making such electric machine according to the invention enable using a rotor which comprises permanent magnets free from rare earths, obtaining a better efficiency of the electric machine due to a drastic reduction of the number of welding spots present in the winding, a lower insulation through resins, a reduction of the resistance to the passage of current in the winding, the removal of the twisting process, a reduction of quality controls inside the process, making it possible to obtain windings on stators with greater active length, with lower costs, better filling of the slots by the winding, and in general a better efficiency of the electric machine being made.

1. A synchronous electric machine (10) with reluctance assisted by permanent magnets comprising:
a rotor comprising: a lamellar pack fastened on a rotation shaft and comprising a plurality of identical sheets, comprising a plurality of axial through-recesses, each sheet comprising a plurality of first axial recesses and permanent magnets, preferably permanent magnets free from rare earths, inserted in the first axial recesses; a plurality of second axial recesses which start from the first axial recesses and arrive next to an edge of a sheet, to form flow barriers;
a stator with closed slots with continuous winding comprising a first, internal stator part which comprises a plurality of longitudinal teeth, spaced by a space configured to make the lower part of the closed slots of the stator; a second, external annular stator part, comprising a plurality of seats complementary with the teeth in the first stator part and configured to be meshed with the first stator part in order to form the closed slots and the stator; a continuous winding comprising at least one strap, which comprises a plurality of first sectors mutually connected by a plurality of second sectors alternate thereto, said at least one strap being configured to be wound on the first, internal stator part, by placing the first sectors into the spaces included between the teeth.

2. The synchronous electric machine with reluctance assisted by permanent magnets according to claim 1, characterized in that the permanent magnets are free from rare earths.

3. The synchronous electric machine with reluctance assisted by permanent magnets according to claim 1, characterized in that said seats obtained in the second stator part are configured to mesh with the teeth of the first stator part in order to form the closed stator slots, through a mutual sliding movement of the first, internal stator part and of the second external part.

4. The synchronous electric machine with reluctance assisted by permanent magnets according to claim 1, characterized in that the first sectors are mutually parallel, being every first sector connected with at least one end thereof to a second sector, and the winding comprises three, mutually alternated straps.

5. A process for making a synchronous electric machine with reluctance assisted by permanent magnets comprising the following steps:
a step of making a rotor by making a lamellar pack comprising a plurality of identical sheets, comprising a plurality of axial through-recesses, each sheet comprising: a plurality of first axial recesses, and permanent magnets inserted in the first axial recesses, and a plurality of second axial recesses which start from the first axial recesses and arrive next to an edge of a sheet, to form flow barriers;
a step of bending on a plane at least one strip to make at least one strap in a single piece, said strap comprising a plurality of first sectors configured to be inserted inside closed slots of a stator and mutually connected by a plurality of second bending sectors configured to remain outside the closed slots of the stator;
a step of providing the stator, said stator comprising a first, internal stator part comprising a plurality of longitudinal teeth, spaced by a space configured to make the lower part of the closed slots of the stator, and a second external annular part of the stator, comprising a plurality of seats complementary to the teeth of the first stator part and configured to be meshed with the first stator part in order to form the closed slots and the stator;
a step of making the winding on the first, internal stator part of said at least one strap, placing the first sectors of the straps into the spaces included between the teeth;
a step of connecting the two free ends of every strap.

6. The process for making a synchronous electric machine with reluctance assisted by permanent magnets according to claim 5, characterized in that it further comprises the following steps:
a step of insulating the welding spots;
a step of checking an absence of connection errors, welding problems or of short-circuit problems.

7. The process for making a synchronous electric machine with reluctance assisted by permanent magnets according to claim 5, characterized in that the first sectors are mutually parallel and alternated with the second sectors, every first sector being connected in at least one end thereof to a second sector.

8. The process for making a synchronous electric machine with reluctance assisted by permanent magnets according to claim 5, characterized in that three straps are made and wound mutually alternated on the first, internal stator part.

9. The process for making a synchronous electric machine with reluctance assisted by permanent magnets according to claim 5, characterized in that it comprises a strap for every electric phase.

10. The process for making a synchronous electric machine with reluctance assisted by permanent magnets according to claim 5, characterized in that, in the step of making the winding, the strap is wound on the first stator part, in the spaces included between the teeth, through a relative rotation of the first, internal stator part with respect to the strap.
